(19) United States
(12) Patent Application Publication
(10) Pub. No.: US 2006/0285580 A1
(43) Pub. Date: Dec. 21, 2006

(54) Combined detection of transmission parameters and spreading factor in CDMA communication system

(76) Inventors: Pasi Kinnunen, Oulu (FI); Kari Horneman, Oulu (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 11/204,124

(22) Filed: Aug. 16, 2005

(30) Foreign Application Priority Data
Jun. 15, 2005 (FI) 20055314

(51) Int. Cl. H04B 1/00

(52) U.S. Cl. 375/147

(57) ABSTRACT

A solution for determining in a radio receiver a data sequence indicating transmission parameters and a spreading factor applied to a frame before receiving the whole frame in the radio receiver. According to the provided solution, the transmission parameters and the spreading factor are determined from received data of a partially received data sequence indicating the transmission parameters of the frame. The received portion of the data is despread with known possible spreading factors and the despread data is compared with corresponding data of known possible transmitted data sequences. Spreading factor-data sequence combination resulting in the best match with the received data is then determined to be the most probably transmitted data sequence. The results of comparison with respect to the spreading factor may be combined with another spreading factor determination procedure for more reliable detection of the correct spreading factor.

### FIELD

The invention relates to a solution for reliable determination of a spreading factor in a code division multiple access (CDMA) based communication system which employs spreading codes with a variable spreading factor.

### BACKGROUND

In a CDMA-based communication system, transmission channels are separated from each other by allocating a different spreading code for each channel. The length of a spreading code is determined with a spreading factor. In order to enable variable data rates for a transmission channel according to the level of traffic within a cell served by a base transceiver station, orthogonal variable spreading factor spreading codes may be utilized in the communication system. The spreading factor applied to a transmission channel may vary during transmission. In a universal mobile communication system (UMTS), for example, a spreading factor may vary between frames. Therefore, at the reception of each frame, the spreading factor used for spreading the data of the frame has to be determined. If the explicit information of the spreading factor is not included in the received signal, blind rate estimation is to be employed at the receiving station in order to define at the receiver the spreading factor and/or the data rate of the received signal. Therefore, a mechanism may be needed for estimating the data rate and/or spreading factor in a radio receiver (e.g. a base transceiver station or a mobile station).

A prior art solution for determining a spreading factor is presented in patent application US 2002/0110140. The solution is an autocorrelation based spreading factor estimator in which a received signal is first despread by using possible spreading factors such that the effects of the spreading code are removed from the signal. An autocorrelation function is then calculated for each despread signal, and the spreading factor is determined based on the results of the autocorrelation computations by selecting the spreading factor which provides the highest autocorrelation value.

### BRIEF DESCRIPTION OF THE INVENTION

An object of the invention is to provide a solution for determining in a radio receiver a data sequence indicating transmission parameters of a frame, the data sequence being a data sequence of a data sequence set known to the radio receiver and the frame comprising a plurality of time intervals.

According to an aspect of the invention, there is provided a method for determining in a radio receiver a data sequence indicating transmission parameters of a frame, the data sequence being a data sequence of a data sequence set known to the radio receiver and the frame comprising a plurality of time intervals. The method comprises receiving data in one or more time intervals, the data being part of a transmitted data sequence indicating transmission parameters of a frame. The method further comprises comparing the received data with corresponding data of each known data sequence of the known data sequence set, selecting, on the basis of the comparison, the data sequence of the known data sequence set which is determined to be closest to the received data, and using the received data of the data sequence indicating the transmission parameters of the frame for determining a spreading factor associated with the frame.

According to another aspect of the invention, there is provided a radio receiver for determining a data sequence indicating transmission parameters of a frame, the data sequence being a data sequence of a data sequence set known to the radio receiver and the frame comprising a plurality of time intervals. The radio receiver comprises a communication interface for reception of data and a control unit being configured to receive, through the communication interface, data in one or more time intervals, the data being part of a transmitted data sequence indicating transmission parameters of a frame. The control unit is further configured to compare the received data with corresponding data of each known data sequence of the known data sequence set, select, on the basis of the comparison, the data sequence of the known data sequence set which is determined to be closest to the received data, and use the received data of the data sequence indicating the transmission parameters of the frame when determining a spreading factor associated with the frame.

According to another aspect of the invention, there is provided a computer program product encoding a computer program of instructions for executing a computer process for determining in a radio receiver a data sequence indicating transmission parameters of a frame, the data sequence being a data sequence of a data sequence set known to the radio receiver and the frame comprising a plurality of time intervals. The process comprises receiving data in one or more time intervals, the data being part of a transmitted data sequence indicating transmission parameters of a frame. The process further comprises comparing the received data with corresponding data of each known data sequence of the known data sequence set, selecting, on the basis of the comparison, the data sequence of the known data sequence set which is determined to be closest to the received data, and using the received data of the data sequence indicating the transmission parameters of the frame when determining a spreading factor associated with the frame.

According to another aspect of the invention, there is provided a computer program distribution medium readable by a computer and encoding a computer program of instructions for executing a computer process for determining in a radio receiver a data sequence indicating transmission parameters of a frame, the data sequence being a data sequence of a data sequence set known to the radio receiver and the frame comprising a plurality of time intervals. The process comprises receiving data in one or more time intervals, the data being part of a transmitted data sequence indicating transmission parameters of a frame. The process further comprises comparing the received data with corresponding data of each known data sequence of the known data sequence set, selecting, on the basis of the comparison, the data sequence of the known data sequence set which is determined to be closest to the received data and using the received data of the data sequence indicating the transmission parameters of the frame when determining a spreading factor associated with the frame.

An advantage the invention provides is more reliable detection of a spreading factor used for spreading data. The invention provides a solution for early detection of transmission parameters and a spreading factor applied to a frame, which speeds up processing of the received data. As a consequence, processing of the received data may be started before the whole frame has been received. This reduces the size of the receiver buffers required in the receiver, which reduces cost and complexity of the receiver. Additionally, the invention may be applied to parallel interference cancellation for more effective interference cancellation.

### LIST OF DRAWINGS

In the following, the invention will be described in greater detail with reference to the embodiments and the accompanying drawings, in which

FIG. 1A illustrates a downlink frame structure of UMTS; FIG. 1B illustrates an uplink frame structure of the UMTS;

FIG. 2 illustrates a structure of a communication system in which embodiments of the invention may be implemented;

FIG. 3 illustrates a structure of a radio receiver in which embodiments of the invention may be implemented; and

FIG. 4 is a flow diagram illustrating a process for combined determination of transmission parameters of a frame and a spreading factor applied to the frame according to an embodiment of the invention.

### DESCRIPTION OF EMBODIMENTS

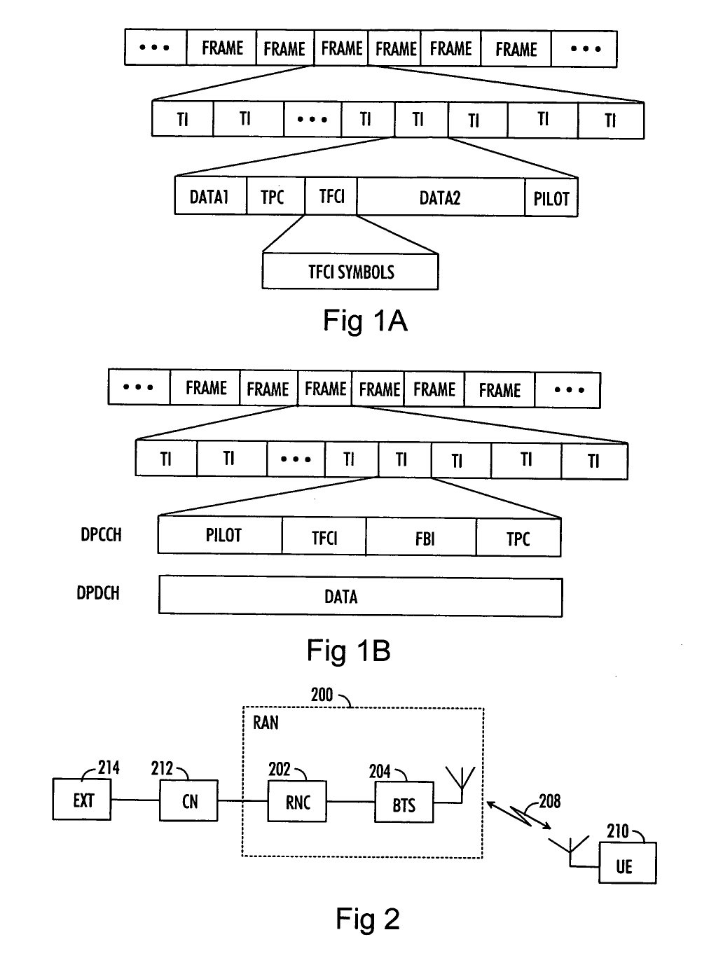

FIG. 1A illustrates a downlink frame structure of Universal Mobile Communications System (UMTS) according to the 3^{rd} Generation Partnership Project (3GPP) specifications. Each frame comprises a plurality of time intervals (or time slots), specifically 15 time intervals (TI). Each time interval comprises portions of data bits (DATA1 and DATA2), a portion of transmit power control bits (TPC), a portion of transport format combination indicator bits (TFCI), and a portion of pilot bits which may be used, for example, in channel synchronisation. FIG. 1B illustrates correspondingly an uplink frame structure of the UMTS. The uplink frame in FIG. 1B comprises data in data channel and TPC, TFCI, and pilot symbols. Additionally the uplink frame comprises feedback information (FBI) symbols.

The TFCI is used for informing a receiver of transmission parameters of the frame. The TFCI may comprise information on how to decode, demultiplex and deliver the received data on the appropriate transport channels. The TFCI also comprises information on the bit rate of the frame which directly indicates a spreading factor applied to the frame. Therefore, it is possible to determine the spreading factor of the frame by determining the TFCI associated with the frame. In UMTS, each TFCI word comprises 10 bits, and the TFCI bits are encoded by using a (32, 10) sub-code of the second order Reed-Muller code in a transmitter. Thus, the result of the encoding process is 32 encoded TFCI bits. In each time interval of a frame, two encoded TFCI bits are transmitted to a receiver. Since there are only 15 time intervals in the frame the last two TFCI bits may be set to zero and, thus, the receiver also knows that the last two bits, which were not transmitted, are zero. Prior to the transmission, the TFCI bits may be mapped (or modulated) into TFCI symbols according to a symbol constellation used in the transmission.

With reference to FIG. 2, examine an example of a data transmission system in which embodiments of the invention may be applied. The structure and the elements of the system illustrated in FIG. 2 are the same as in the Universal Mobile Telecommunication System (UMTS) network, but it should, however, be noted that implementation of the proposed data detection method is not limited to the UMTS system, but it may also be implemented in other suitable communication systems which employ variable spreading factor orthogonal spreading codes and frame-structured data transfer with each frame comprising a plurality of time intervals (or time slots), and a data sequence indicating transmission parameters of a frame being distributed over several time intervals.

The network elements of the communication system of FIG. 2 can be grouped into the radio access network (RAN) 200 that handles all radio-related functionalities of the system, and a core network (CN) 212, which takes care of switching and routing calls and data connections to external networks 214. External network may be for example the Internet, Integrated Services Digital Network (ISDN), or Public Switched Telephone Network (PSTN).

The radio access network 200 comprises one or several base transceiver stations (BTS) 204, or node Bs which is the equivalent term in the 3GPP specifications, and radio network controllers (RNC) 202. A BTS 204 is responsible for providing an air interface radio connection 208 to the subscriber units 210 within its coverage area also known as a cell. The BTS 204 also performs physical level signal processing like modulation, channel coding, etc. The BTS 204 may also perform some basic radio resource management operations like operations related to power control.

A radio network controller 202 is the network element which is responsible for the control of radio resources in the RAN 200. The RNC 202 serves as a switching and controlling element of the RAN 200 and typically controls several BTSs 204, but it may also control only a single BTS 204. RNC 202 is responsible for controlling load and congestion of traffic channels of its own cells. The RNC 202 also takes care of procedures related to admission control, handovers, and power control. The radio network controller 202 typically includes a digital signal processor and software for executing computer processes stored on a computer readable medium. Furthermore, the radio network controller 202 typically includes connecting means for communicating electric signals with other network elements, such as other radio network controllers and/or base transceiver stations, but also with the core network 212.

The core network 212 provides a combination of switching and transmission equipment, which together form a basis for telecommunication network services. The core network also performs procedures related to radio resource management. The core network 212 may provide circuit-switched and/or packet-switched data transport services to the user entities.

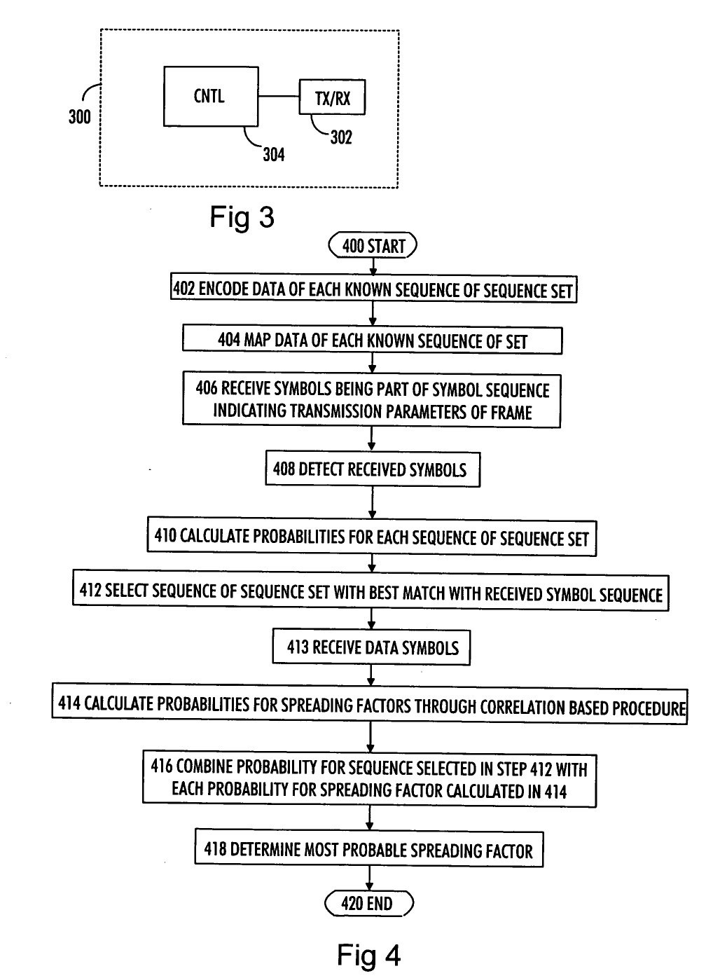

Next, the structure of a radio receiver 300 will be described with reference to FIG. 3. The radio receiver 300 may be a subscriber unit of a communication system such as a mobile communication device, or a computer with a communication interface to provide a radio connection. The radio receiver may also be a network element of a communication system, such as a base transceiver station or an access point to a communication network.

The radio receiver 300 comprises a communication interface 302 to receive, in conjunction with an antenna, information signals transmitted over a radio connection. If the radio receiver 300 is a subscriber unit, the communication interface 302 may provide a connection with a communication network through a serving base transceiver station or an access point. The communication interface 302 may also provide capability to transmit information signals over a radio interface.

The radio receiver 300 further comprises a control unit 304 to control functions of the radio receiver 300. The control unit 304 may comprise means for retrieving information from a received signal. The retrieval procedure may comprise determining a spreading factor together with transmission parameters of a frame in reception from received data of a data sequence indicating the transmission parameters of the frame, and processing the frame in reception according to the determined transmission parameters. The control unit 304 may be implemented with a digital signal processor with suitable software embedded in a computer readable medium, or with separate logic circuits, for example with ASIC (Application Specific Integrated Circuit).

Next, determination of a symbol sequence describing transmission parameters of a frame together with determination of a spreading factor of the spreading code of the frame is depicted with reference to the downlink of the UMTS. It should, however, be appreciated that the invention is limited neither to the downlink direction nor to the UMTS and may be implemented in the uplink direction and in other communication systems as well.

During the establishment of a connection between a subscriber unit and a radio network, a higher-level protocol may select a set of possible transport format combinations with each transport format combination being represented by a transport format combination indicator (TFCI) described above. This set may be referred to as a transport format combination set (TFCS). The TFCS may be transmitted to both the base station and the subscriber unit. Transmission parameters of frames used in communication between a subscriber unit and a base station may be selected by a medium access control (MAC) protocol located in a radio network controller. The transmission parameters are selected by selecting a TFCI associated with the desired transmission parameter from the TFCS. As mentioned above, the TFCI is a data sequence indicating the transmission parameters of a frame.

When communication between the base station and the subscriber unit is active, the base station receives data from the radio network controller to be transmitted to the subscriber unit. The base station processes the data according to parameters indicated by the TFCI currently in use. The TFCI indicates, among other things, how to map transport channels which are used in communication between the base station and the radio network controller into dedicated channels which are used in communication with the base station and the subscriber unit and how to encode the data to be transmitted. After processing the data, the base station transmits the data to the subscriber unit in a frame-structured format.

The whole frame may be processed according to one TFCI and the TFCI corresponding to the frame is also transmitted to the subscriber unit such that the TFCI is distributed over the plurality of time intervals of the frame. Each time interval may comprise part of the TFCI sequence. The TFCI bits may be encoded in the transmitter (the base station in this example) using a determined coding scheme. The encoded TFCI bits may also be mapped and modulated into symbols according to a symbol constellation used in the transmission.

As mentioned above, the TFCS is also known to the receiver (subscriber unit in this example), and this information may be used in detection of the correct TFCI of a frame. When the receiver has received a determined amount of TFCI symbols, given by desired reliability of the detection, it may initiate a procedure for determining the transmitted TFCI. The desired reliability may be selected from a preset table. The more received TFCI symbols are included in the determination procedure, the more reliable the result is.

The UMTS employs orthogonal variable spreading factor (OVSF) spreading codes for spreading data. When considering communication between a base transceiver station and a subscriber unit, a spreading factor may change from frame to frame. Therefore, the spreading factor used for spreading data of a frame is determined for each frame. In UMTS, the spreading factor of a control channel (for example a dedicated physical control channel, DPCCH) is fixed and known to the receiver but the spreading factor of a frame of a data channel (for example a dedicated physical data channel, DPDCH) has to be determined, for example, by determining the TFCI (transmitted in the control channel) associated with the frame.

For the detection of the TFCI of the frame, the receiver may first encode each TFCI sequence of the known TFCS by using the same coding scheme as was used for the TFCI sequence of the frame in the transmitter. As a result TFCI code words are obtained. These TFCI code words of the TFCS may then be stored in the receiver such that there is no need to encode them at the reception of every frame.

At the reception of each time interval of the frame, the receiver may pick the TFCI symbols from the data of the time interval and demodulate, detect, and remove mapping of the TFCI symbols in order to obtain detected TFCI bits which are still in the encoded format. The demodulation, the detection, and the removal of mapping may be carried out using a procedure known in the art.

When a determined amount of detected TFCI bits have been obtained, the detected TFCI bits are compared with the corresponding TFCI bits of each encoded TFCI code word of the TFCS in the receiver. For example, if the first eight TFCI bits have been detected, these bits are compared with the first eight bits of each encoded TFCI code word of the TFCS. The comparison may be carried out using, for example, the following equation:

$$dist 1 ( i ) = \frac{1}{{N}_{TFCI}} {\sum }_{n = 1}^{{N}_{TFCI}} \vert {TFCI}_{cw , i} ( n ) - {TFCI}_{rx} ( n ) \vert , \qquad ( 1 )$$

where dist(i) is the distance between the received detected TFCI bits and the TFCI bits of a TFCI code word of the TFCS, i is an index discriminating each TFCI of the TFCS (i runs from one to the number of TFCIs in the TFCS), N_{TFCI} is the number TFCI bits included in the comparison, TFCI_{cw,i}(n) corresponds to the n^{th} TFCI bit of the i^{th} TFCI code word of the TCFS, and TFCIᵣₓ(n) corresponds to the nth TFCI bit of the received and detected part of the transmitted TFCI code word. As can be seen, equation (1) measures distance (or difference) between the received detected TFCI bits and the corresponding TFCI bits of each TFCI code word of the TFCS. Thus, after comparing each TFCI code word with the received detected TFCI bits, the TFCI code word with the lowest distance [dist1(i)] to the received detected TFCI bits is selected, and transmission parameters of the frame are determined based on that selection. Now, that the transmission parameters of the frame have been determined, the receiver may start processing the data of the received time intervals by decoding, demultiplexing and delivering the received data on the appropriate transport channels before the whole frame has been received. The receiver also finds out the bit rate and, consequently, the spreading factor applied to the data in the data channel.

When reception of a new frame is started, a new comparison between the newly received TFCI bits (which have been demodulated and detected) and the corresponding TFCI bits of each TFCI code word of the TFCS may be carried out.

Upon computation of equation (1), two (or more) TFCI code words may have an equal result dist1(i). In this case, it may be determined that additional received TFCI symbols has to be included in the comparison. Therefore, the receiver may wait for reception of an additional TFCI symbol or symbols and recalculate equation (1) with the additional information. The distances may be calculated for those TFCI code words which had equal dist1(i) in order to reduce computational load, or dist1(i) may be calculated for each TFCI code word. After the recalculation, the TFCI code word with the highest dist1(i) may be selected.

When reception of a new frame is started, a new comparison between the newly received TFCI symbols and the corresponding TFCI bits of each TFCI code word of the TFCS is carried out and the transmitted new TFCI code word is determined.

According to another embodiment of the invention, detection of the transmitted TFCI code word may be carried out without a need to remove mapping of the received detected TFCI symbols. According to this embodiment, each known TFCI code word of the TFCS may be encoded by using a determined coding scheme and mapped into mapped TFCI bits according to the symbol constellation used in the transmission of the TFCI bits in the transmitter, yielding TFCI code word symbols for each TFCI code word of the TFCS.

Again, at the reception of each time interval of the frame, the receiver may pick the TFCI symbols from the data of the time interval, demodulate and detect them. When a determined amount of detected TFCI symbols have been obtained, the received detected TFCI symbols may be compared with the corresponding mapped TFCI bits of each TFCI code word by using the following equation:

$$dist 2 ( i ) = \frac{1}{{N}_{TFCIS}} {\sum }_{n = 1}^{{N}_{TFCIS}} {TFCI}_{cws , i} ( n ) {TFCI}_{rxs}^{*} ( n ) , \qquad ( 2 )$$

where dist2(i) is the result of the comparison between the received detected TFCI symbols and the mapped TFCI bits of a TFCI code word of the TFCS, i is an index discriminating each TFCI code word of the TFCS (i runs from one to the number of TFCI code words in the TFCS), N_{TFCIS} is the number of TFCI symbols included in the calculation of the equation (2), TFCI_{cws,i}c(n) is the n^{th} mapped TFCI bit of the i^{th} TFCI code word of the TFCS, TFCIᵣₓₛ(n) is the n^{th} received, detected TFCI symbol and * denotes complex conjugate operation. As can be seen, equation (2) multiplies the complex conjugates of the received detected TFCI symbols with the corresponding mapped TFCI bits of the i^{th} TFCI code word and calculates an average value from these multiplications. Therefore, the TFCI code word which results in highest dist2(i) is selected as the most likely transmitted TFCI code word, and the transmission parameters of the frame are determined on the basis of that selection. Now that the transmission parameters of the frame have been determined, the receiver may start processing the data of the received time intervals by decoding, demultiplexing and delivering the received data on the appropriate transport channels before the whole frame has been received. The spreading factor of the data channel may also be determined at this stage.

The spreading factor may be determined based on computation of equation (1) or (2) solely by determining the TFCI with the highest dist1(i) or dist2(i), determining the bit rate associated with the frame indicated by the TFCI and selecting the spreading factor associated with the determined bit rate, but the computations of equation (1) or (2) with respect to the selected TFCI code word may be utilized together with another procedure for determining the spreading factor. The other procedure for determining the spreading factor may be, for example, based on calculation of autocorrelation values from a determined amount of received data symbols despread by using a possible set of spreading factors. The data symbols may be data symbols carrying user data on a dedicated physical data channel of the UMTS, for example.

As mentioned above, the receiver may have knowledge of possible spreading factors, the number of possible spreading factors being denoted as K. The received symbol sequence from which the spreading factor is to be estimated may be despread by multiplying the received symbol sequence with the spreading code with K different spreading factors. The sampling rate remains the same as before despreading which means that no integration over a sample interval determined by the used spreading factor is performed. As a result, K despread symbol sequences are obtained with each despread symbol of a despread symbol sequence comprising a number of samples determined by the spreading factor associated with the despread symbol sequence. Then, autocorrelation values may be computed for each despread symbol sequence according to the following equation:

$$C ( k ) = ℛ [ {\sum }_{l = 1}^{L} {\sum }_{j = 1}^{J / 2} S1 ( l ( j ) , k ) S2 ⋆ ( 1 ( j ) , k ) ] , \qquad ( 3 )$$

where C(k) represents an autocorrelation value for a symbol sequence despread by using the k^{th} spreading factor, R denotes taking a real part, L is the number of despread symbols included in the computation, J is the number of samples per symbol, S1(l,k) denotes the first half of the samples of the l^{th} symbol despread by using the k^{th} spreading factor, S2(l,k) denotes the other half of the samples of the l^{th} symbol despread by using the k^{th} spreading factor, and * denotes complex conjugate. For example, let us focus on computation of C(k) for one symbol (L=1). Assume that the symbol has been despread by using a spreading factor of 4 and the despread symbol comprises four samples (J=4). The first sample of the symbol is multiplied with the complex conjugate of the third sample and the second sample is multiplied with the complex conjugate of the fourth sample, and the results of the multiplications are summed up. As a result, an autocorrelation value for the despread symbol is obtained. If the symbol was despread with the correct spreading factor, the samples would have approximately the same values and, thus, the autocorrelation value would be high. On the other hand, if the symbol was despread with an incorrect spreading factor, one or more samples might have substantially different values than others, and, thus, the autocorrelation value would be low. Usually, several symbols are included in calculation of equation (2) for the sake of reliability of the determination of the correct spreading factor.

As described above, a spreading factor may be determined through two different ways. Probability values [dist1(i); C(k)] have been determined according to equations (1) and (3), respectively. Instead of equation (1), equation (2) may be used. The two probability values may be used together for more reliable detection of the spreading factor. The probability values for a spreading factor may be combined according to the following equation:

$${P}_{tot} ( k ) = 2 [ sign ( C ( k ) ) \sqrt{\vert C ( k ) \vert} - 0.5 ] + \frac{128 {P}_{C}}{{P}_{dist}} dist ( {i}^{′} , k ) , \qquad ( 4 )$$

where Pₜₒₜ(k) represents the total probability of the spreading factor k being the correct spreading factor, “sign(·)” denotes sign function of (·) (plus or minus), C(k) represents a probability value for spreading factor k obtained by computation of equation (3), [·] denotes an absolute value, P_{C} denotes received signal power associated with received symbols included in computation of C(k) according to equation (3), P_{dist} denotes received signal power associated with received symbols included in computation of dist1(i′) according to equation (1), and dist1(i′) represents a probability value for a TFCI code word selected based on the computation of equation (1) with i′ denoting the selected TFCI code word, i.e. the most probable transmitted TFCI code word. P_{c} and P_{dist} may be calculated according to a procedure known in the art. The power scaling is used for removing the effects of a difference in the power of the received symbols included in calculation of equation (1) and the received symbols included in calculation of equation (3). If the same symbols were used in calculation of both equations (1) and (3), then P_{c} is equal to P_{dist} and they can be reduced from equation (4).

In the above description, downlink case has been described. Naturally, the determination of transmission parameters of a frame according to the embodiments of the invention may be carried out in uplink case, too. In the uplink case, a base transceiver station, for example, may be the radio receiver performing the determination of the transmission parameters.

Determination of a spreading factor according to an embodiment or embodiments described above may be used, for example, in parallel interference cancellation (PIC). The PIC may be carried out in a base transceiver station, for example. The purpose of the PIC is to minimize the effects of multiple access interference (MAI) caused by non-orthogonality of the spreading codes in a receiver. When removing the effects of MAI with respect to a spreading code, the PIC may be carried out by detecting data associated with other spreading codes through tentative decisions of transmitted bits, regenerating the transmitted signals, summing up the signals, and subtracting the summed signal from the received signal. In order to detect the data associated with other spreading codes, spreading factors of the spreading codes have to be determined. The spreading factors may be determined according an embodiment or embodiments described above for each spreading code separately. For example, in the UMTS a spreading factor of an interfering spreading code may be determined from the received TFCI symbols. The spreading factor may be determined together with determination of the transmitted TFCI code word through calculation of equation (1) or (2) and, if more reliable detection of the spreading factor is desired, through calculation of equations (3) and (4) as described above. An advantage of this embodiment is that the spreading factors and the transmitted TFCI code words may be determined before the transmitted TFCI code word has been completely received. Thus, further processing of the received data (removing the multiple access interference, decoding, demultiplexing, etc.) may be started before the whole frame is received thereby reducing the required size of receiver buffers and the receiver complexity.

Next, there will be described a process for determining a data sequence indicating transmission parameters of a frame in reception together with determining a spreading factor of the spreading code of the frame in a radio receiver according to an embodiment of the invention with reference to a flow diagram of FIG. 4. The frame comprises a plurality of time intervals. The data sequence indicating the transmission parameters of the frame may be a TFCI of the UMTS, for example, and may be distributed over the plurality of time intervals. The data sequence is a data sequence of a data sequence set known to the radio receiver. The data sequence may be, for example, a sequence of data mapped data bits. The process starts in step 400.

In step 402, each data sequence of the data sequence set known to the radio receiver are encoded by using the same coding scheme used for encoding the data sequence indicating the transmission parameters of the frame in a transmitter. In step 404, each encoded data sequence of the data sequence set known to the radio receiver are mapped into mapped data bits by using the same symbol constellation as used for mapping the encoded data sequence indicating the transmission parameters of the frame in the transmitter. In step 406, data symbols being part of the symbol sequence indicating the transmission parameters of the frame are received in the radio receiver. In step 408, the received data symbols are detected in order to obtain detected symbols. Prior to the detection, the received symbols may be despread.

In step 410, probabilities for each mapped data sequence are calculated in order to determine the transmitted data sequence indicating the transmission parameters of the frame. The probabilities may be calculated according to equation (1) or (2). Encoded data sequence which results in the highest probability is selected as the most probably transmitted data sequence indicating the transmission parameters of the frame in step 412. In step 413, data symbols are received, the data symbols being associated with the same frame as the received symbols indicating the transmission parameters of the frame. The received data symbols may be despread by using each spreading factor of a known spreading factor set comprising spreading factors possibly used for spreading the received symbols in a transmitter. In step 414, probabilities for each possible spreading factor are calculated through correlation-based procedure. The probabilities may be calculated according to equation (3) as described above.

In step 416, the probability for the data sequence selected in step 412 is combined with the probabilities for spreading factors calculated in step 414. In order to level the probabilities, either set of probabilities may have to be scaled. The combination may be carried out according to equation (4). In step 418, the most probable spreading factor is determined by selecting a spreading factor associated with the highest probability value obtained after processing step 416. The process ends in step 420.

The embodiments of the invention may be realized in an electronic device, comprising a communication interface and a control unit operationally connected to the communication interface. The control unit may be configured to perform at least some of the steps described in connection with the flowchart of FIG. 4. The embodiments may be implemented as a computer program comprising instructions for executing a computer process for detecting in a radio receiver a symbol sequence indicating transmission parameters of a frame, the symbol sequence being a symbol sequence of a symbol sequence set known to the radio receiver and the frame comprising a plurality of time intervals.

The computer program may be stored on a computer program distribution medium readable by a computer or a processor. The computer program medium may be, for example but not limited to, an electric, magnetic, optical, infrared or semiconductor system, device or transmission medium. The medium may be a computer readable medium, a program storage medium, a record medium, a computer readable memory, a random access memory, an erasable programmable read-only memory, a computer readable software distribution package, a computer readable signal, a computer readable telecommunications signal, and/or a computer readable compressed software package.

Even though the invention has been described above with reference to an example according to the accompanying drawings, it is clear that the invention is not restricted thereto but it can be modified in several ways within the scope of the appended claims.

1. A method for determining in a radio receiver a data sequence indicating transmission parameters of a frame, the data sequence comprising a data sequence of a data sequence set known to the radio receiver and the frame comprising a plurality of time intervals, the method comprising:
receiving data in one or more time intervals, the data comprising part of a transmitted data sequence indicating transmission parameters of a frame;
comparing the received data with corresponding data of each known data sequence of the known data sequence set and outputting results indicative thereof;
selecting, based on the comparison, the data sequence of the known data sequence set which is determined to be closest to the received data; and
using the received data of the data sequence indicating the transmission parameters of the frame for determining a spreading factor associated with the frame.

2. The method of claim 1, wherein the data sequence comprises a bit sequence, and the method further comprises:
encoding each bit sequence of the known bit sequence set with a same code used for encoding the bit sequence indicating the transmission parameters of the frame in a transmitter;
receiving encoded bits in the one or more time intervals, the encoded bits comprising part of an encoded bit sequence indicating the transmission parameters of the frame; and
comparing the received encoded bits with the corresponding bits of each known encoded bit sequence of the known bit sequence set.

3. The method of claim 2, wherein the comparing comprises comparing based on a calculation of a difference between the received encoded bits and corresponding bits of each known encoded bit sequence of the known bit sequence set.

4. The method of claim 3, wherein the comparing comprises comparing based on the following equation:
$$dist 1 ( i ) = \frac{1}{{N}_{TFCI}} {\sum }_{n = 1}^{{N}_{TFCI}} \vert {TFCI}_{cw , i} ( n ) - {TFCI}_{rx} ( n ) \vert , \qquad ( 1 )$$
where: dist1(i) is the difference between the received encoded bits and the corresponding bits of an i^{th} known encoded bit sequence of the known bit sequence set,
N_{TFCI} is a number of received encoded bits included in the comparison,
TFCI_{cw,i}(n) corresponds to an n^{th} bit of the i^{th} known encoded bit sequence of the known bit sequence set and
TFCIᵣₓ(n) corresponds to an n^{th} bit of the received encoded bits of the encoded bit sequence indicating the transmission parameters of the frame.

5. The method of claim 1, wherein the data sequence comprises a bit sequence and the method further comprising:
encoding each bit sequence of the known bit sequence set with a same code used for encoding the bit sequence indicating the transmission parameters of the frame in a transmitter;
mapping each encoded bit sequence of the known bit sequence set by using a same symbol constellation used for mapping the bit sequence indicating the transmission parameters of the frame in the transmitter, to obtain mapped bits of each encoded bit sequence of the known bit sequence set;
receiving symbols in the one or more time intervals, the symbols comprising part of a transmitted symbol sequence comprising an indication of the transmission parameters of the frame detecting the received symbols; and
comparing the received detected symbols with the corresponding mapped bits of each encoded bit sequence of the known bit sequence set.

6. The method of claim 5, wherein the comparing comprises comparing based on the following equation:
$$dist 2 ( i ) = \frac{1}{{N}_{TFCIS}} {\sum }_{n = 1}^{{N}_{TFCIS}} {TFCI}_{cws , i} ( n ) {TFCI}_{rxs}^{*} ( n ) , \qquad ( 2 )$$
where: dist2(i) is a result of the comparison between the received detected symbols and the corresponding mapped bits of an i^{th} encoded bit sequence of the known bit sequence set;
N_{TFCIS} is a number of received symbols included in the calculation of the above equation;
TFCI_{cws,i}(n) is an n^{th} mapped bit of the i^{th} encoded bit sequence of the known bit sequence set;
TFCIᵣₓₛ(n) is an nth received symbol; and
* denotes a complex conjugate operation.

7. The method of claim 1, further comprising:
receiving symbols in the one or more time intervals, the received symbols comprising other symbols than the symbols that are part of a transmitted symbol sequence comprising indication of the transmission parameters of the frame; and
despreading the received symbols by using each spreading factor of a spreading factor set comprising spreading factors used for spreading the received symbols in a transmitter to obtain a number of despread symbol sequences with each symbol sequence being despread by using a determined spreading factor.

8. The method of claim 7, further comprising:
calculating probability values for each spreading factor by applying a correlation-based probability calculation procedure to each despread symbol sequence;
determining a spreading factor associated with the selected data sequence of the data sequence set, the data sequence indicating the transmission parameter of the frame;
combining the calculated probability values with the results obtained for each spreading factor at the comparison with respect to the selected data sequence of the data sequence set; and
selecting the spreading factor with a highest combined probability value as the most probable spreading factor.

9. The method of claim 1, further comprising:
initiating the comparison upon reception of a determined amount of data of the data sequence indicating the transmission parameters of the frame.

10. The method of claim 9, further comprising:
indicating the transmission parameters of the frame based on desired reliability of the detection using the determined amount of data of the data sequence.

11. The method of claim 1, further comprising:
determining, after comparison, whether additional data indicating the transmission parameters of the frame is to be included in the comparison before selecting the data sequence of the known data sequence set closest to the received data;
receiving the additional data indicating the transmission parameters of the frame when determining that the additional data indicating the transmission parameters of the frame is to be included in the comparison; and
comparing the received data, including the additional data, with each known data sequence of the known data sequence set.

12. The method of claim 1, further comprising:
indicating the transmission parameters of the frame being distributed over the time intervals of the frame using the data sequence.

13. The method of claim 1, further comprising:
determining transmission parameters of the frame before reception of the whole frame.

14. The method of claim 1, wherein the method is configured to suppress multiple access interference through parallel interference cancellation.

15. A radio receiver for determining a data sequence indicating transmission parameters of a frame, the data sequence comprising a data sequence of a data sequence set known to the radio receiver and the frame comprising a plurality of time intervals, the radio receiver comprising:
a communication interface to receive of data; and
a control unit configured to
receive, through the communication interface, data in one or more time intervals, the data comprising part of a transmitted data sequence indicating transmission parameters of a frame,
compare the received data with corresponding data of each known data sequence of the known data sequence set and outputting results indicative thereof,
select based on the comparison, the data sequence of the known data sequence set determined to be closest to the received data, and
use the received data of the data sequence indicating the transmission parameters of the frame when determining a spreading factor associated with the frame.

16. The radio receiver of claim 15, wherein the data sequence comprises a bit sequence, and the control unit is further configured to
encode each bit sequence of the known bit sequence set with a same code used for encoding the bit sequence indicating the transmission parameters of the frame in a transmitter,
receive encoded bits of one or more time intervals, the encoded bits comprising part of an encoded bit sequence indicating the transmission parameters of the frame, and
compare the received encoded bits with the corresponding bits of each known encoded bit sequence of the known bit sequence set.

17. The radio receiver of claim 16, wherein the control unit is configured to compare by calculating a difference between received encoded bits and corresponding bits of each known encoded bit sequence of the known bit sequence set.

18. The radio receiver of claim 17, wherein the control unit is configured to compare by calculating the following equation:
$$dist 1 ( i ) = \frac{1}{{N}_{TFCI}} {\sum }_{n = 1}^{{N}_{TFCI}} \vert {TFCI}_{cw , i} ( n ) - {TFCI}_{rx} ( n ) \vert , \qquad ( 1 )$$
where: dist(i) is the difference between the received encoded bits and the corresponding bits of an i^{th} known encoded bit sequence of the known bit sequence set,
N_{TFCI} is a number of received encoded bits included in the comparison,
TFCI_{cw,i}(n) corresponds to an n^{th} bit of the i^{th} known encoded bit sequence of the known bit sequence set, and
TFCIᵣₓ(n) corresponds to an n^{th} bit of the received encoded bits of the encoded bit sequence indicating the transmission parameters of the frame.

19. The radio receiver of claim 15, wherein the data sequence comprises a bit sequence, and the control unit is further configured to
encode each bit sequence of the known bit sequence set with a same code used for encoding the bit sequence indicating the transmission parameters of the frame in a transmitter,
map each encoded bit sequence of the known bit sequence set by using a same symbol constellation used for mapping the bit sequence indicating the transmission parameters of the frame in the transmitter to obtain mapped bits of each encoded bit sequence of the known bit sequence set,
receive through the communication interface symbols in the one or more time intervals, the symbols comprising part of a transmitted symbol sequence comprising an indication of the transmission parameters of the frame,
detect the received symbols, and
compare the received symbols with the corresponding mapped bits of each encoded bit sequence of the known bit sequence set.

20. The radio receiver of claim 19, wherein the control unit is configured to compare by calculating the following equation:
$$dist 2 ( i ) = \frac{1}{{N}_{TFCIS}} {\sum }_{n = 1}^{{N}_{TFCIS}} {TFCI}_{cws , i} ( n ) {TFCI}_{rxs}^{*} ( n ) \qquad ( 3 )$$
where: dist2(i) is a result of the comparison between the received symbols and the corresponding mapped bits of an i^{th} encoded bit sequence of the known bit sequence set,
N_{TFCIS} is a number of received symbols included in the calculation of the above equation,
TFCI_{cws,i}(n) is an n^{th} mapped bit of the i^{th} encoded bit sequence of the known bit sequence set,
TFCIᵣₓₛ(n) is an n^{th} received symbol, and
* denotes a complex conjugate operation.

21. The radio receiver of claim 15, wherein the data sequence comprises a bit sequence, and the control unit is further configured to
receive through the communication interface symbols in the one or more time intervals, the received symbols comprising other symbols than the symbols comprising part of a transmitted symbol sequence comprising indication of the transmission parameters of the frame, and
despread the received symbols by using each spreading factor of a spreading factor set comprising spreading factors used for spreading the received symbols in a transmitterto obtain a number of despread symbol sequences with each symbol sequence being despread by using a determined spreading factor.

22. The radio receiver of claim 21, wherein the data sequence comprises a bit sequence, and the control unit is further configured to
calculate probability values for each spreading factor by applying a correlation-based probability calculation procedure to each despread symbol sequence,
determine a spreading factor associated with the selected data sequence of the data sequence set, the data sequence indicating the transmission parameter of the frame,
combine the calculated probability values with the results obtained for each spreading factor at the comparison with respect to the selected data sequence of the data sequence set, and
select the spreading factor with a highest combined probability value as the most probable spreading factor.

23. The radio receiver of claim 15, wherein the control unit is further configured to initiate the comparison upon reception of a determined amount of data of the data sequence indicating the transmission parameters of the frame.

24. The radio receiver of claim 15, wherein the control unit is further configured to:
determine, after comparison, whether additional data indicating the transmission parameters of the frame should be included in the comparison before selecting the data sequence of the known data sequence set closest to the received data;
receive through the communication interface, the additional data indicating the transmission parameters of the frame when determining that the additional data indicating the transmission parameters of the frame is to be included in the comparison; and
compare the received data, including the additional data, with each known data sequence of the known data sequence set.

25. The radio receiver of claim 15, wherein the data sequence indicating the transmission parameters of the frame is distributed over the time intervals of the frame.

26. The radio receiver of claim 15, wherein the control unit is further configured to determine the transmission parameters of the frame before reception of the whole frame.

27. The radio receiver of claim 15, wherein the radio receiver is configured to suppress parallel interference cancellation in the radio receiver.

28. A radio receiver for determining a data sequence indicating transmission parameters of a frame, the data sequence comprising a data sequence of a data sequence set known to the radio receiver and the frame comprising a plurality of time intervals, the radio receiver comprising:
communication means for reception of data;
means for receiving, through the communication means, data in one or more time intervals, the data comprising part of a transmitted data sequence indicating transmission parameters of a frame;
means for comparing the received data with corresponding data of each known data sequence of the known data sequence set;
means for selecting based on the comparison, the data sequence of the known data sequence set determined to be closest to the received data; and
means for using the received data of the data sequence indicating the transmission parameters of the frame when determining a spreading factor associated with the frame.

29. A computer program embodied in a computer-readable medium encoding instructions for executing a computer process for determining in a radio receiver a data sequence indicating transmission parameters of a frame, the data sequence comprising a data sequence of a data sequence set known to the radio receiver and the frame comprising a plurality of time intervals, the computer program performing a process comprising:
receiving data in one or more time intervals, the data comprising part of a transmitted data sequence indicating transmission parameters of a frame;
comparing the received data with corresponding data of each known data sequence of the known data sequence set;
selecting based on the comparison, the data sequence of the known data sequence set determined to be closest to the received data; and
using the received data of the data sequence indicating the transmission parameters of the frame when determining a spreading factor associated with the frame.

30. A computer program distribution medium readable by a computer and encoding a computer program of instructions for executing a computer process for determining in a radio receiver a data sequence indicating transmission parameters of a frame, the data sequence comprising a data sequence of a data sequence set known to the radio receiver and the frame comprising a plurality of time intervals, the computer program performing a process comprising:
receiving data in one or more time intervals, the data comprising part of a transmitted data sequence indicating transmission parameters of a frame;
comparing the received data with corresponding data of each known data sequence of the known data sequence set;
selecting, based on the comparison, the data sequence of the known data sequence set determined to be closest to the received data; and
using the received data of the data sequence indicating the transmission parameters of the frame when determining a spreading factor associated with the frame.

31. The computer program distribution medium of claim 30, wherein the computer program distribution medium comprises at least one of the following mediums: a computer readable medium, a program storage medium, a record medium, a computer readable memory, a computer readable software distribution package, a computer readable signal, a computer readable telecommunications signal, and a computer readable compressed software package.
